(19) United States
(12) Patent Application Publication
(10) Pub. No.: US 2007/0221531 A1
(43) Pub. Date: Sep. 27, 2007

(54) Packetized Colorization of Coatings

(76) Inventor: Patrick Raymond Coughlin, Medina, OH (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/691,278

(22) Filed: Mar. 26, 2007

Related U.S. Application Data
(60) Provisional application No. 60/743,798, filed on Mar. 27, 2006.

(51) Int. Cl. B65D 85/84; C04B 14/00; B01F 15/00

(52) U.S. Cl. 206/524.7; 106/401; 366/348

(57) ABSTRACT

Various systems and methods are provided for the conditioning and/or colorization of a coating. In one embodiment, a packet is provided that is constructed from a material dissolvable in the coating. The packet contains a quantity of dry powder substance, the dry powder substance being pretreated to disperse in the coating. The quantity of the dry powder substance in the packet imparts a predefined quality to a predefined volume of the coating when the packet is added to the predefined volume of the coating, the integrity of the packet is compromised by at least partial dissolution so that the dry powder substance is released, and the dry powder substance is substantially dispersed in the coating.

### CROSS REFERENCE TO RELATED CASE

This application claims priority to co-pending U.S. Provisional Patent Application 60/743,798 entitled “Packetized Colorization of Coatings,” filed on Mar. 27, 2006, which is incorporated herein in its entirety.

### BACKGROUND

In the coatings industry, colorization of architectural and specialty coatings at the point of sale is accomplished using pigments in liquid form that are added to architectural and specialty coatings. This usually requires expensive liquid tinting equipment and mixing equipment that must be maintained and operated at the point of sale of architectural and specialty coatings such as paint and the like. In the typical case, a customer picks out a color from a multitude of possible options displayed on color swatches and the like. Also, the customer may select a type of paint they wish to use. Thereafter, the customer will bring the paint and the color swatch to a store employee who will add the colors to the paint and mix the paint using the liquid tinting equipment and the mixing equipment. As many may attest, this process can take quite a bit of time, especially if multiple customers are waiting to be served in this manner. In addition, the store is charged with the task of maintaining the colorization equipment and maintaining inventories of liquid pigments, ready mixed colors, and short filled bases to be used in colorization. Also, from time to time, store personnel may make mistakes in using the liquid dispensing equipment, thereby resulting in unnecessary waste of product and time.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a drawing of a packet of dry powder pigment for colorization of a coating according to an embodiment of the present invention;

FIG. 2 is a drawing of a thickness of a material employed in a packet of FIG. 1 according to an embodiment of the present invention;

FIG. 3 is a drawing of a distribution of the architectural coating from a bulk container into containers that are individually colorized using a packet of dry powder pigment as described in FIG. 1 according to an embodiment of the present invention;

FIG. 4 is a drawing of the colorization of a coating using multiple packets as described in FIG. 1, the packets including various colors of dry powder pigments according to an embodiment of the present invention;

FIG. 5 is a drawing of the colorization of a coating using multiple packets as described in FIG. 1, wherein each of the packets includes a mix of dry powder pigments of different colors according to an embodiment of the present invention;

FIG. 6 is a drawing that shows steps of a method for the colorization of a coating using at least one dry powder packet as described in FIG. 1 according to an embodiment of the present invention;

FIG. 7 is a drawing that shows steps of a method for the colorization of a coating using at least one dry powder packet as described in FIG. 1 according to an embodiment of the present invention; and

FIG. 8 is a drawing that shows a labeled package that contains at least one dry powder packet as described in FIG. 1 according to an embodiment of the present invention.

### DETAILED DESCRIPTION

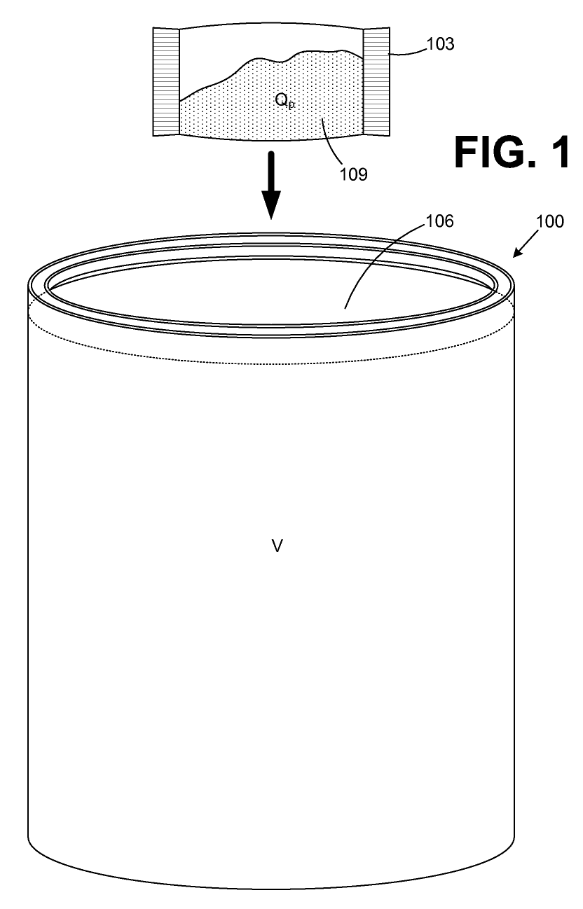

Referring to FIG. 1, shown is a container 100 and a packet 103. A volume V of coating 106 is contained within the container 100. The coating 106 may comprise, architectural coatings, industrial coatings, or specialty coatings such as, for example paint, stain, or other coating as will be described. Architectural and industrial coatings 106 are those used, for example, to paint or otherwise coat the inner or outer surfaces of machinery or structures or for other purposes as can be appreciated. Specialty coatings 106 may be those coatings used for special purposes such as, for example, art, crafts, and for other purposes as can be appreciated. The container 100 may be of a predefined volume V that holds a corresponding volume V of coating 106. In this respect, the volume V may be, for example, one gallon, five gallons, two liters, or any other volume as can be appreciated. The container 100 may include volume indicators comprising, for example, markings, protrusions, or other indicators to identify the precise levels to which the container 100 can be filled in order to measure various volumes of coating 106. Thus, the same container 100 may be used to measure multiple different volumes V of coating 106 as is the case with standard measuring cups and the like. In this respect, as set forth above, the volume V may be measured in terms of the English measurement system, the metric system, or any other measurement system. The container 100 may be constructed from metal, plastic, or any other material. In this respect, the container 100 may comprise a paint can of any size, or a 5 gallon paint bucket, etc.

The packet 103 holds a predefined quantity Q of a dry powder pigment 109 according to an embodiment of the present invention. The pigment 109 may comprise a uniform color or may be a blend of colors. The material from which the packet 103 is constructed is dissolvable in the coating 106. According to one embodiment, the dry powder pigment 109 in the packet 103 is employed to tint or colorize the coating 106 in the container 100. In one embodiment, the coating 106 to which the packets 103 are added does not contain any pigment. Such coatings 106 are termed “clear” and are generally deemed to be “neutral” in the art as can be appreciated. Alternatively, the coating 106 may already include preexisting pigment dispersed therein that imparts an initial color to the coating such as white or any other initial color, etc. Such coatings 106 may be, for example, a color tone, transparent, semi-transparent, or opaque.

In order to colorize the paint 106, the packet 103 is dropped into the coating 106 in the container 100. Given that the packet 103 is constructed from a material that is dissolvable in the coating 106, the material that makes up the packet 103 dissolves in the coating 106. The time it takes to dissolve the material that makes up the packet 103 may be reduced by agitating the coating 106 by shaking, stirring, or other agitation. The dry powder pigment 109 contained in the packet is pretreated using any dry dispersion technology so as to be able to disperse in the coating 106 upon agitation.

When the material that makes up the packet 103 is dissolved, the dry powder pigment 109 is completely released into the coating 109 and can disperse into the coating 106. However, it should be noted the dry powder pigment 109 may be at least partially released to disperse into the coating 106 when the integrity of the packet 103 is compromised, for example, by at least partial dissolution of the material that makes up the packet 103. In an additional alternative, a portion of the material that makes up the packet 103 such as a panel may be dissolvable, where the pigment 109 is at least partially released when the integrity of this portion of the packet 103 is compromised by at least partial dissolution. Ultimately, the quantity Q_{P} of the dry powder pigment 109 in its color proportions in the packet 103 imparts a predefined color to the volume V of the coating 106 when the pigment 109 is fully dispersed in the coating 106.

The coating 106 may comprise any one of a number of different types of coatings 106. For example, the coating 106 may include interior and exterior paints. These coatings may be water-based, solvent based, and/or a hybrid blend of water and solvent carriers. A solvent is a carrier within which another substance may be dissolved or dispersed. In this respect, a solvent may comprise, for example, solvents such as thinner or mineral spirits as can be appreciated. In this respect, the coatings 106 may be oil based, alkyd based, latex based, acrylic based, or may be based in some other resin. The coatings 106 may be embodied, for example, in the form of paints, sealers, stains, clear finishes and other coatings 106 as can be appreciated. Thus, the coatings 106 may comprise one of various types including, for example, clears, naturals, toners, transparents, translucents, semi-transparents, opaques, and other types. Opaque coatings 106 may comprise pastel base, mid/intermediate base, and deep base as can be appreciated.

The pigment 109 may comprise organic and inorganic pigments. In this respect, the dry powder pigments 109 may include yellow iron oxide, red iron oxide, lamp black, umbers, phthallo blue, phthallo green, hansa yellow, quinacridone reds, quinacridone magenta, red transparent iron oxide, yellow transparent iron oxide, black transparent iron oxide, umber transparent iron oxide, brown transparent iron oxide and other types of pigments. In addition, the dry powder pigments 109 may also comprise ultra or nano particle pigments such as titanium dioxide and zinc oxide. In addition, the dry powder pigments 109 may comprise any other type of pigment not expressly described herein that can be pretreated so as to be dispersed into a coating as described herein according to the various embodiments of the present invention.

The dry powder pigments 109 may impart other qualities to a coating 106 other than colorization. For example, substances such as titanium dioxide and zinc oxide that are typically classified as dry powder pigments 109 may be used primarily to impart a degree of ultraviolet (UV) protection or absorption to the coating 106. Alternatively, other substances that can be classified as dry powder pigments 109 may impart other qualities to the coating 106 such as, for example, opacity. Such dry powder pigments 109 may not significantly change the color of the coating 106 such as might be the case, for example, where the primary purpose is to impart a degree of UV protection to the coating 106.

The dry powder pigments 109 may comprise a pigment of a single color, or may comprise a blend of multiple colors. In this respect, where the dry powder pigment 109 comprises multiple colors, the dry powder pigment 109 may actually be a mix of multiple different types of dry powder pigments as described above. Such mixtures may be employed to impart a multitude of various colors to the coating 106 as can be appreciated.

The material that makes up the packet 103 dissolves or is dissolvable in the coating 106. Specifically, the material may be dissolvable in a water-based coating, a solvent based coating or a hybrid of water/solvent based coatings 106. It is understood that it may not be necessary to completely dissolve the packets 103 in order to substantially free the dry powder pigment 109 to be dispersed into the coating 106. Thus, as employed herein, the term “dissolve” is defined as either to completely dissolve, or substantially dissolve the material. In any event, the material that makes up the packet 103 is specified so that it may be at least partially dissolved in the coating 106 so as to compromise the integrity of the packet 103 such that the dry powder pigment 109 is at least partially released so that it may be dispersed into the coating 106. In one embodiment, the packet 103 is completely dissolved in the coating 106 to effect the complete release of the dry powder pigment 109 contained therein. In other embodiments, the packet 103 or a portion thereof may only need to be dissolved to effect the substantial release of all of the pigment contained therein. The material that makes up the packet 103 may comprise, for example, a polyvinyl alcohol water soluble film (PVOH), a poly copolymer blend, or other type of material. Such materials are manufactured by various companies such as Aicello North America, Inc. of North Vancouver, British Columbia; MonoSol, LLC of Portage, Indiana; Cortex Corporation of St. Paul, Minn., Akrochem Corporation of Akron, Ohio, Suncolor Corporation of North Canton, Ohio, Polymer Packaging, Inc., of North Canton, Ohio, and other manufacturers as can be appreciated.

Also, to the extent that the term “disperse,” or any form of such term, is employed herein in conjunction with the dry powder pigment and the coating 106, it refers to either the complete or partial dispersal of the dry powder pigment 109 into the coating 106. Thus, for example, the dry powder pigment 109 is substantially dispersed when the surface area of the particles of the dry powder pigment 109 is substantially “wetted out” or surrounded by the vehicle of the coating 106 (i.e. carrier and resin) and the particles of the dry powder pigment 109 are substantially distributed throughout the volume of coating 106. While a complete and uniform dispersal of dry powder pigment 109 into the coating 106 is preferred, it is possible that a near complete or substantial dispersal of the same is acceptable for purposes of the various embodiments of the present invention.

The quantity Q of the dry powder pigment 109 in the packet 103 is associated with the volume V of the coating 106 in the container 100. The container 100 either exactly or approximately holds a volume V of the coating 106. In this respect, the volume of coating 106 that may be held in the container is that to which the dry powder pigment 109 imparts a predefined color, where the coating 106 may be clear or an initial color, such as, for example, white, or other color as can be appreciated.

Thus, the quantity Q of dry powder pigment and the volume Q of the coating 106 are related in that, to impart a specific color to the coating 106, the dry powder pigment must be uniformly dispersed in the coating at a specific concentration. Thus, the quantity Q of the dry powder pigment necessary to achieve the desired concentration that translates into the desired color of the coating 106 depends on the volume V of the coating 106. The actual quantity of dry powder pigment relative to a given volumes V of coating 106 may be calculated or determined on an empirical basis.

According to the various embodiments of the present invention, the use of the dry powder pigment 109 in the packet 103 for colorization of the coating 106 provides distinct advantages. In one embodiment, the packets 103 may be placed on a shelf in a store environment and may be directly accessible to consumers as opposed to liquid pigments that are typically handled by store personnel. Also, the packets 103 may be mixed into the coating 106 by way of stirring by consumers themselves, rather than requiring store personnel to help. Consequently, consumers need not wait for store personnel to colorize and mix coatings using expensive and complicated equipment as was described above.

In the event that store personnel add colorants to the coating 106 and place the coating on a shaker machine, the process of colorization is quicker as the store personnel do not have to operate complicated liquid pigment dispensing equipment. Also, stores would not have to train store personnel on how to use such equipment, making it easier to train more personnel in a given store to perform the colorization function since the process is easier to understand, thereby streamlining the process at the point of sale. In addition, the various embodiments eliminate the need for stores to maintain an inventory of ready mixed colors of coatings where coatings are sold in a ready mixed state as is typical for stores. In this respect, a coating that comprises “ready mixed colors” is one that is sold in the state in which it is to be applied to a surface without further colorization.

Given that the material that makes up a packet 103 dissolves in the coating 106, the dry powder pigment 109 is thus free to disperse completely in the coating 106. Consequently, a very precise quantity Q of the dry powder pigment 109 may be applied to the coating 106. Consequently, all of the dry powder pigment 109 is dispersed into the coating 106 rather than pouring the dry powder pigment out of a packet into the coating 106, for example, where a portion of the dry powder pigment 109 may still remain stuck in creases of the package, or may be accidentally dumped outside of the container 100 during the attempt to add the dry powder pigment to the coating 106.

In addition, given that the dry powder pigments 109 are contained within the packets 103, there is no chance for the dry powder pigments 109 to escape the packets 103 and stain various surfaces or create messes that require clean up during the process of colorization. Also, the dry powder pigments 109 do not displace a significant volume of the coating 106 within the container 100, thereby eliminating any requirement for the container 100 to be short filled with the coating 106 so as to make room for liquid colorants.

In addition, the dry powder pigments 109 are treated for maximum dispersion within the coating 106 to provide deeper, richer, and crisper translucent colors with a maximum of clarity. Also, in other embodiments, dispersion of the dry powder pigments 109 may result in increased blockage of rays from the sun, thereby enhancing the performance of the coating in terms of the longevity of the coating 106 and protection that the coating 106 provides to surfaces upon which it is applied as is the case with pigments comprising, for example, transparent iron oxides. In this respect, some pigments available in the form of the dry powder pigment may not be readily available in liquid form, thereby providing a greater selection of pigments. The use of the dry powder pigments 109 and the packets 103 further eliminates the necessity of maintaining a significant inventory of liquid colorants, thereby reducing the cost of operation at the point of sale of coatings 106. Also, stores need not purchase and maintain expensive liquid coloring equipment to provide for colorization of coatings 106. Rather, stores need only to maintain sufficient quantities of the packets 103 on the shelf that may be directly accessible by consumers. In addition, the various embodiments of the present invention provide additional benefits beyond those specifically described herein.

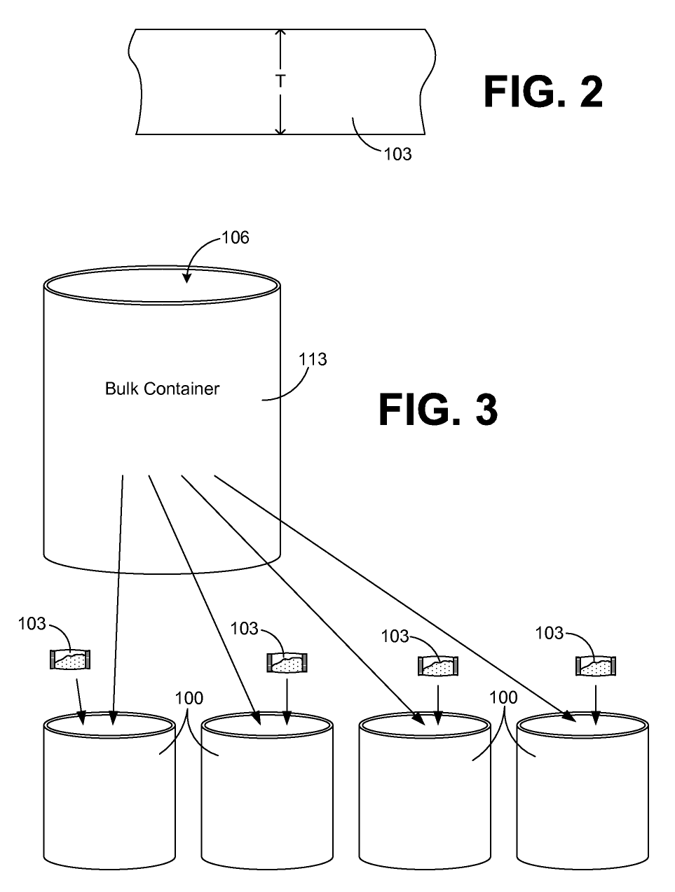

Referring then to FIG. 2, shown is a drawing of a portion of the material that makes up the packet 103 according to an embodiment of the present invention. As shown, the material has a thickness T. The thickness T, grade, and other characteristics of the material that makes up the packet 103 bears on the dissolvability of the packet 103 in the coating 106. In this respect, the thickness T, grade, or other characteristic of the material that makes up the packet 103 is specified so as to contain the dry powder pigment 109 without spillage or leakage due to handling, shipping, and storage, etc. At the same time the thickness T, grade, or other characteristic of the material that makes up the packet 103 is specified so as to provide for maximum dissolvability in the coating 106 within a minimum of time given the agitation that is applied to the coating 106 after the packet 103 is dropped therein. An acceptable period of time for dissolving the packet 103 and releasing the dry powder pigment 109 therein for dispersion into the coating 106 may be, for example, less than three minutes in a coating 106 at 77° F., although other time periods greater or less than 3 minutes at other temperatures may be acceptable. In another example benchmark, the material of the packet 103 should be specified so as to dissolve in a neat solvent at a specified temperature in less than one minute. It is understood, however, that other time periods and mixing temperatures would be acceptable beyond those expressly described herein.

With reference next to FIG. 3, shown is a drawing that illustrates the distribution of coating 106 from a bulk container 113 to a number of containers 100 according to an embodiment of the present invention. In this respect, coating 106 may be purchased or supplied in the bulk containers 113 and then distributed to individual containers 100 to which one or more packets 103 may be added. The dry powder pigment 109 contained in the one or more packets 103 is dispersed within the coating 106 within the containers 100 by agitation according to the various embodiments of the present invention.

Thus, in one embodiment, a significant advantage may be gained in that coating 106 may be sold in bulk quantities in bulk containers 113 and individuals can then distribute the coating 106 to smaller containers 100 for colorization. Thus, for example, a consumer that wishes to paint or stain their house multiple different colors will be able to buy a single volume of coating 106 in a bulk container along with a multitude of different dry powder pigments 109 of different colors in various packets 103. The consumer can then distribute the paint to containers 100 of appropriate sizes depending upon the volumes specified on the packets 103 and may colorize the paint into various colors as needed.

Thus, the quantity Q of dry powder pigment 109 within the packets 103 may be associated with various different measurements of volume V of the containers 100. For example, some quantities of paint might be small, such as, for example, a pint, quart, or other quantity, whereas other quantities might be very large, such as, for example, a gallon or multiple gallons, etc. Thus, by purchasing the packets 103 with dry powder pigment 109 of appropriate quantities Q along with the coating 106 in bulk volumes, the consumer can thus paint or stain structures of many different colors and not waste paint that would normally have to be purchased in containers of standard sizes when lesser amounts of paint for various colors may be all that is needed. Also, the consumer may employ the same paint bought in the bulk container for several projects separated in time, where the packets 103 are purchased as needed. In addition, the coating 106 that is sold in bulk containers 103 may be less expensive as greater amounts of coating 106 may be sold with less containers used for transportation storage at the factory and store locations, etc.

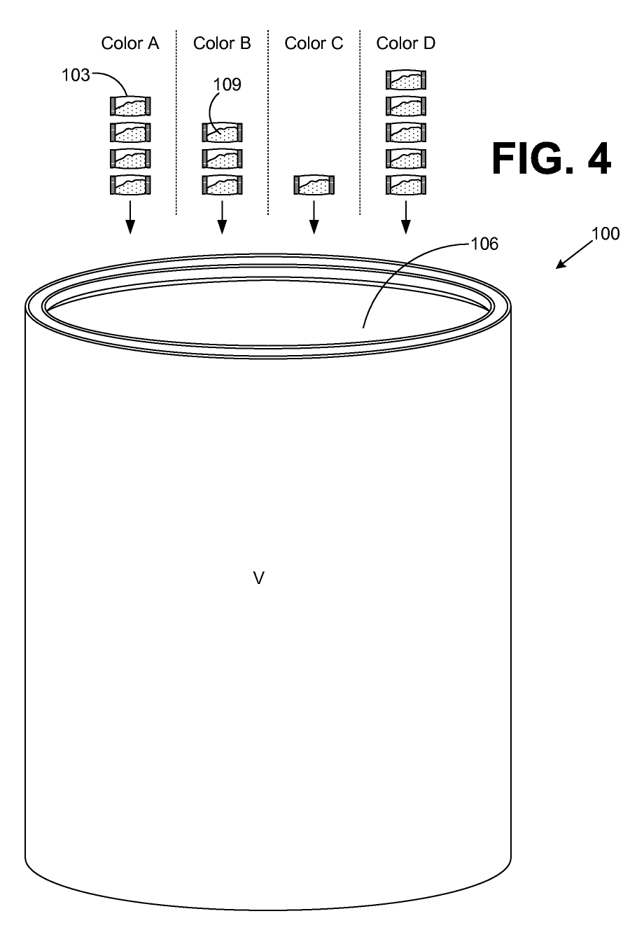

With reference next to FIG. 4, shown is an approach for colorization of coating 106 according to an embodiment of the present invention. In this embodiment, a standard quantity of the dry powder pigment 109 is included in the packets 103, and multiple packets 103 are added to the coating 106 in the container 100 for colorization. In this respect, each of the packets 103 includes a standard component quantity of dry powder pigment 109. Each packet 103 may include dry powder pigment 109 that is of a specific color. For example, each of the packets 103 contain dry powder pigment 109 of colors A, B, C, or D as shown. The ultimate quantity of dry powder pigment 109 comprising the addition of each component quantity of dry powder pigment 109 in each of the packets 103 imparts a predefined color to a given volume V of coating 106 contained in the specified volume V of the container 100.

The use of component quantities of dry powder pigments 109 in the packets 103 provides significant flexibility in terms of determining the ultimate color of the coating 106 to which the packets 103 are added. By creating packets 103 that contain the component quantities of dry powder pigment 109, various colors can be imparted to the coating 106 by adding various combinations of the packets 103 of respective colors of dry powder pigment 109 to the coating 106. This provides a significant amount of flexibility in order to determine the ultimate colors of coatings 106 desired by consumers, while at the same time, allowing the packets 103 to be manufactured with standard component quantities of pigment 109. As a result, the packets 103 may be manufactured without using various formulas of quantities of dry powder pigments 109 of different colors to be applied to the coating 106 as was described with reference to FIG. 1. Thus, the cost of producing the packets 103 may be significantly reduced.

In addition, where consumers wish to have custom colors made, a color formula may be determined based on a sampling process as is generally known by those with ordinary skill in the art. Using this formula, the numbers of packets 103 that contain the dry powder pigments 109 of various colors may be determined in order to most closely match the sampled color. In addition, it may be possible to create packets 103 of component quantities of dry powder pigment 109 of multiple colors where such resulting color blends are desirable.

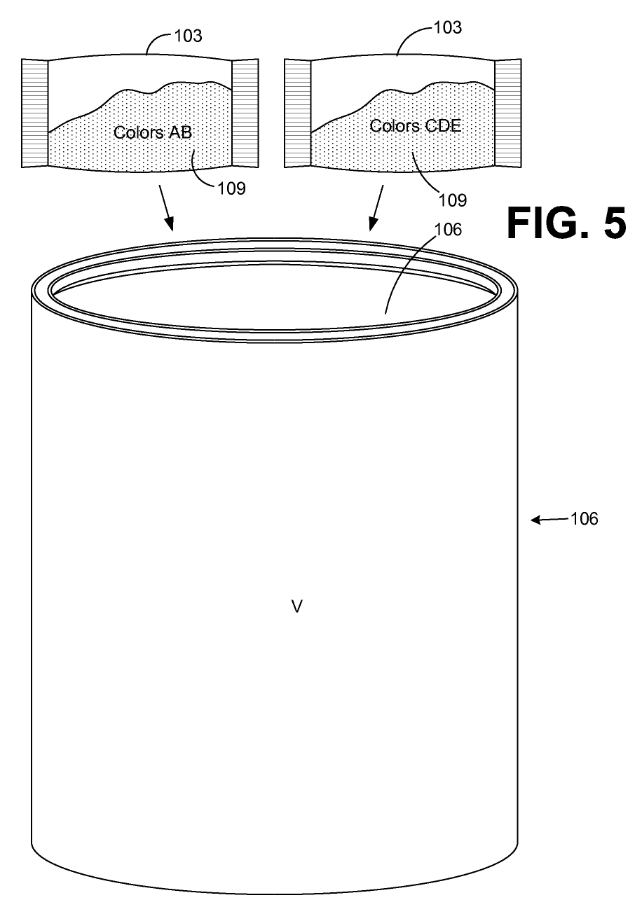

Referring next to FIG. 5, shown are packets 103 according to another embodiment of the present invention. The packets 103 contain component quantities of dry powder pigment 109 of multiple colors. For example, one of the packets 103 contains colors, for example, A and B, whereas the second one of the packets 103 contains, for example, colors C, D, and E. The colors of dry powder pigment 109 in either of the packets 103 may vary in quantity relative to each other depending upon the ultimate color to be imparted to the coating 106. Thus, the packets 103 can contain component quantities of dry powder pigment 109 of multiple colors as was described above. The component quantities may be standard component quantities or custom component quantities in order to obtain a given color. It should be appreciated that by mixing multiple packets 103 containing blends of multiple pigments, the number of ultimate colors that may be created increases significantly.

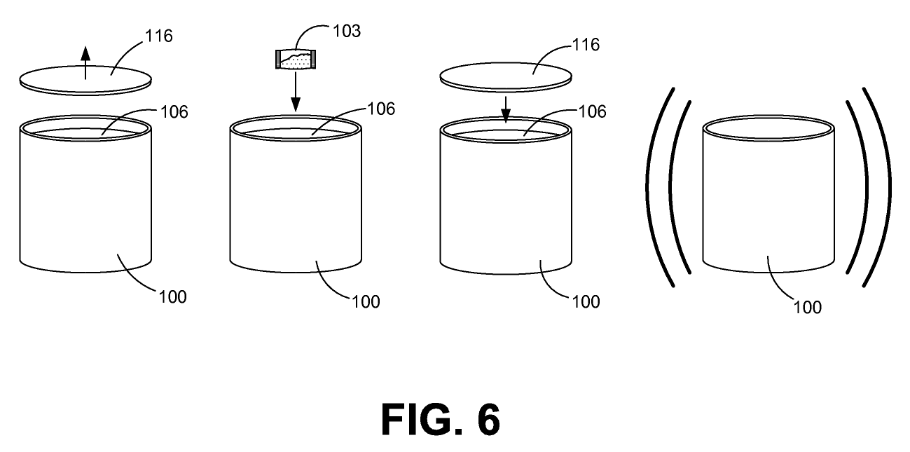

Referring to FIG. 6, shown is a graphical illustration of the steps of a method employed to colorize coatings 106 according to an embodiment of the present invention. In one embodiment, in a first step the lid 116 is removed from the container 100 to expose the coating 106 contained therein. Thereafter, in the next step, one or more packets 103 are added to the coating 106 in the container 100. Next, the lid 116 is placed back onto the container 100, thereby sealing the coating 106 therein.

Finally, the container 100 is agitated. This may be done, for example, using a mixing device such as, for example, various retail mixing equipment available on the market. For example, mixing equipment that may be employed includes the 5400 Standard and the 5315 Speed Demon marketed by Red Devil Equipment Company of Plymouth, Minn. Also, mixers that may be employed are the Miller Model G Shaker, H-1 Mixer, Gyro Mixer, and Harbil Mixers/Shakers manufactured by Fluid Management of Wheeling, Illinois. In addition, other types of mixers and shakers may be available on the market to cause the agitation of the container 100 and the coating 106 contained therein.

Due to the agitation, the material of the one or more packets 103 added to the coating 106 is dissolved and the dry powder pigment 109 contained in the one or more packets 103 is dispersed into the coating 106, thereby imparting a predefined color to the coating 106 in the container 100. To achieve complete dissolution of the material of the packets 103, the agitation may need to be performed for a minimum period of time, depending upon the material itself as described above.

In addition, while the packets 103 of dry powder pigment 109 are described as being added to coating 106 in containers 100 as described above, it is possible that packets 103 may be added to coatings that are contained in some manner within a bulk process such as a holding tank, stream, or method of containment. Such bulk processes may be of the type that generate large quantities of coatings 106, where the quantity of pigment 109 contained in the packets 103 that are added during such processes relate to the amount of coating 106 to which the dry powder pigment 109 in the packets 103 will be exposed and into which the dry powder pigment 109 is dispersed.

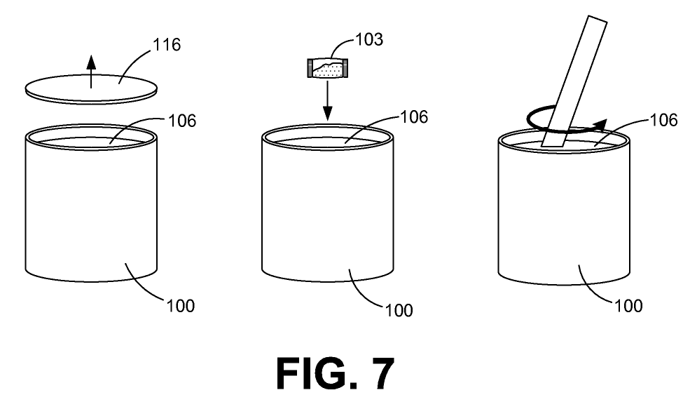

With reference to FIG. 7 shown is a second method in which the coating 106 is colorized according to an embodiment of the present invention. In the embodiment shown, the container 100 is opened by removing the lid 116 therefrom, thereby exposing the coating 106 contained therein. In the next step, one or more packets 103 of dry powder pigment 109 are dropped into the coating 106 in the container 100. Thereafter, in a final step the coating 106 is stirred using, for example, a stirring stick or other stirring device. For example, alternative stirring devices include stirring devices that are attached to drills or other rotating machinery, or paddles and the like that are attached to other types of machinery, etc. The coating is thus agitated by the stirring preferably until the material that makes up the packets 103 is dissolved in the coating 106 and the dry powder pigment 109 contained therein is substantially dispersed within the coating 106.

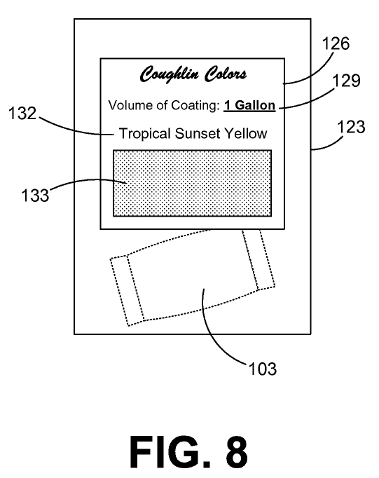

With reference to FIG. 8, shown is an approach to packaging the packets 103 according to an embodiment of the present invention. In this respect, at least one of the packets 103 is contained within a package 123 that is offered for sale to purchasers. As shown, a package 123 is provided that contains one or more packets 103 according to an embodiment of the present invention. A label 126 is associated with the one or more packets 103 in the package 123 by being presented on the package 123. Alternatively, the label 126 may be associated with the packets 103 in some other manner such as, for example, by stapling the label 126 to one or more of the packets, etc. The package 123 may be constructed from cardboard (i.e. such as a box), paper, plastic, or any other packaging as can be appreciated.

The label 126 indicates a volume 129 of the coating 106 to which the one or more packets 103 are to be applied in order to impart a predefined color to the coating 106. In addition, the label 126 includes a color description 132 and/or a swatch 133 of color that corresponds to the predefined color imparted to the coating 126 by the dispersal of the dry powdered pigment 109 into the coating 106. In this respect, the dry powder pigment 109 contained in the one or more packets 103 may comprise a single color or a blend of colors as was described herein. Also, the one or more packets 103 associated with the label 126 may include a standard component quantity of the dry powder pigment 109 as was described above.

By virtue of the fact that the label 126 is associated with the packets 103, a consumer may be made aware of the volume of coating 106 to which the packets 103 in the package 123 are to be applied, and the precise color of the coating 106 that will be imparted to the volume of coating 106. The color of the swatch 133 is the color of the coating 106, for example, after it has been applied to a surface and has cured as can be appreciated. Thus, a purchaser is provided with all information that is necessary to purchase and use the packets 103. As a result, there is no need to employ specialized personnel for the colorization of coatings 106 and other benefits are obtained as described herein or will be apparent based upon the description of the various embodiments herein.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

What is claimed is:

1. A system for the colorization of a coating, comprising:
a packet constructed from a material dissolvable in the coating; and
a quantity of dry powder pigment in the packet, the dry powder pigment being pretreated to disperse in the coating, wherein the quantity of the dry powder pigment in the packet imparts a predefined color to a predefined volume of the coating when the packet is added to the predefined volume of the coating, the integrity of the packet is compromised by at least partial dissolution so that the dry powder pigment is at least partially released, and the dry powder pigment is substantially dispersed in the coating.

2. The system of claim 1, wherein the dry powder pigment is completely released upon a complete dissolution of the packet in the coating.

3. The system of claim 1, wherein the dry powder pigment is substantially released upon a substantial dissolution of the packet in the coating.

4. The system of claim 1, wherein the material substantially dissolves in the predefined volume of the coating in less than 3 minutes of stirring by hand.

5. The system of claim 1, wherein the material substantially dissolves in the predefined volume of the coating after less than approximately 3 minutes of agitation using an industrial agitation apparatus.

6. The system of claim 1, wherein the coating comprises a carrier that is taken from a group of carriers consisting of water, solvent, oil, or a water/solvent hybrid.

7. The system of claim 1, wherein the dry powder pigment comprises an organic pigment.

8. The system of claim 1, wherein the dry powder pigment comprises an inorganic pigment.

9. The system of claim 1, wherein the dry powder pigment comprises a blend of at least two colors.

10. The system of claim 1, wherein the predefined volume of the coating is associated with the packet.

11. The system of claim 10, wherein a label is associated with the packet, the predefined volume appears on the label.

12. The system of claim 11, wherein the predefined color appears on the label.

13. The system of claim 10, wherein the label is associated with a package within which the packet is contained.

14. A method for coloring a predefined volume of a coating, comprising the steps of:
adding at least one packet constructed from a material dissolvable in the coating to the predefined volume of the coating, the packet containing a quantity of dry powder pigment, the dry powder pigment being pretreated to disperse in the coating; and
agitating the predefined volume of the coating after the at least one packet is added to compromise the integrity of the packet by at least partial dissolution so as to at least partially release the dry powder pigment and to disperse the dry powder pigment in the coating, thereby imparting a predefined color to the coating.

15. The method of claim 14, wherein the material of the packet is substantially dissolvable in less than approximately 3 minutes.

16. The method of claim 14, wherein the coating is neutral.

17. The method of claim 14, wherein the coating includes an initial amount of preexisting pigment imparting an initial color thereto.

18. The method of claim 14, wherein the predefined volume of the coating is in a container, and the step of adding the at least one packet to the predefined volume of the coating is performed by dropping the at least one packet into the coating in the container.

19. The method of claim 18, further comprising the step of distributing the predefined volume of the coating from a bulk container to the container, the bulk container having a volume greater than a volume of the container.

20. The method of claim 14, wherein the step of agitating the predefined volume of the coating further comprises the step of stirring the predefined volume of coating.

21. The method of claim 20, wherein the predefined volume of the coating is stirred by hand.

22. The method of claim 14, wherein the step of agitating the predefined volume of the coating further comprises the step of mixing the predefined volume of coating using a mixing apparatus.

23. The method of claim 14, wherein the step of adding the at least one packet to the predefined volume of coating further comprises the step of adding a plurality of packets to the volume of coating, wherein the dry powder pigment in a first one of the packets is of a first color and the dry powder pigment in a second one of the packets is of a second color, wherein the first color is different than the second color.

24. The method of claim 14, wherein the step of adding the at least one packet to the predefined volume of coating further comprises the step of adding a plurality of packets to the volume of coating, wherein at least one of the packets contains a first dry powder pigment of a first color and a second dry powder pigment of a second color, where the first color is different that the second color.

25. A system for the colorization of a coating, comprising:
at least one packet constructed from a material dissolvable in the coating, and a quantity of dry powder pigment contained in the at least one packet, the dry powder pigment being pretreated to disperse in the coating; and
a label associated with the at least one packet, the label indicating a volume of the coating to which the at least one packet is to be applied, wherein the dry powder pigment contained in the at least one packet imparts a predefined color to the volume of the coating when the at least one packet is added to the volume of the coating, the integrity of the packet is compromised by at least partial dissolution, and the dry powder pigment is released and substantially dispersed in the coating.

26. The system of claim 25, wherein the at least one packet is contained in a package, wherein the label is associated with the at least one packet by being presented on the package.

27. The system of claim 25, wherein the label further comprises a swatch of predefined color.

28. The system of claim 25, wherein the label further comprises a description of the predefined color.

29. The system of claim 25, wherein the dry powder pigment contained in the at least one packet comprises a plurality of colors.

30. The system of claim 25, wherein the at least one packet further comprises a plurality of packets, wherein a standard quantity of the dry powder pigment is contained in each of the packets.

31. A system for conditioning a coating, comprising:
a packet constructed from a material dissolvable in the coating; and
a quantity of a dry powder substance in the packet, the dry powder substance being pretreated to disperse in the coating, wherein the quantity of the dry powder substance in the packet imparts a predefined quality to a predefined volume of the coating when the packet is added to the predefined volume of the coating, the integrity of the packet is compromised by at least partial dissolution so that the dry powder substance is at least partially released, and the dry powder substance is substantially dispersed in the coating.

32. The system of claim 31, wherein the dry power substance imparts a degree of ultraviolet protection to the coating.

33. The system of claim 31, wherein the dry powder substance is completely released upon a complete dissolution of the packet in the coating.

34. The system of claim 31, wherein the dry powder substance is substantially released upon a substantial dissolution of the packet in the coating.

35. The system of claim 31, wherein the coating comprises a carrier that is taken from a group of carriers consisting of water, solvent, oil, or a water/solvent hybrid.

36. The system of claim 31, wherein at least a portion of the dry powder substance further comprises a dry powder pigment.
